(19) United States
(12) Patent Application Publication
(10) Pub. No.: US 2019/0021130 A1
(43) Pub. Date: Jan. 17, 2019

(54) METHOD FOR CHANGING CONNECTION MODE AND MOBILITY MANAGEMENT ENTITY

(71) Applicant: LG ELECTRONICS INC., Seoul (KR)

(72) Inventors: Taehun KIM, Seoul (KR); Laeyoung KIM, Seoul (KR); Jinsook RYU, Seoul (KR); Jaehyun KIM, Seoul (KR); Sangmin PARK, Seoul (KR)

(73) Assignee: LG ELECTRONICS INC., Seoul (KR)

(21) Appl. No.: 16/069,053

(22) PCT Filed: Jan. 20, 2017
(86) PCT No.: PCT/KR2017/000708

§ 371 Date: Jul. 10, 2018

Related U.S. Application Data
(60) Provisional application No. 62/281,185, filed on Jan. 20, 2016.

(51) Int. Cl. H04W 76/20; H04W 72/04

(52) U.S. Cl. CPC H04W 76/20; H04W 88/18; H04W 72/042

(57) ABSTRACT

When the amount of downlink (DL) data for a user equipment (UE), buffered by a network, exceeds a predetermined reference value, the network establishes a user plane connection with the UE by changing a connection mode with the UE. Even when a control plane connection that can be used for user data transmission exists and access to the UE is possible, the network does not transmit the DL data to the UE on the control plane connection, but transfers the DL data to the UE after the user plane connection is established.

### TECHNICAL FIELD

The present invention relates to a wireless communication system and, more particularly, to a method and apparatus for changing a connection mode.

### BACKGROUND ART

A wireless communication system has been widely deployed to provide a diverse range of communication services such as a voice communication service and a data communication service. Generally, the wireless communication system is a sort of multiple access system capable of supporting communication with multiple users by sharing available system resources (e.g., bandwidth, transmit power, etc.). For example, the multiple access system may include one of a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, a multi-carrier frequency division multiple access (MC-FDMA) system, and the like.

Recently, various devices that require machine-to-machine (M2M) communication and a high data transfer rate, such as smartphones or tablet personal computers (PCs), have appeared and come into widespread use. This has rapidly increased the quantity of data which needs to be processed in a cellular network. In order to satisfy such rapidly increasing data throughput, various technologies such as a carrier aggregation (CA) technology for efficiently using more frequency bands, a cognitive ratio technology, a multi-antenna technology for increasing data capacity in a restricted frequency, a multi-base station (BS) cooperative technology, and the like have been developed.

In addition, communication environments have evolved such that the density of accessible nodes is increased in the vicinity of a user equipment (UE). Here, the node means a fixed point capable of transmitting/receiving radio signals to/from UEs using one or more antennas. The communication system where the node density is high may provide high quality communication services to UEs through cooperation between nodes.

### DETAILED DESCRIPTION OF THE INVENTION

### Technical Problems

Due to the introduction of new radio communication technologies, the number of UEs to which a BS should provide a service in a prescribed resource region increases and the amount of uplink data and uplink control information that the BS should receive from the UEs increases. Since the amount of resources available to the BS for communication with the UE(s) is finite, a new method in which the BS efficiently transmits/receives data and/or control information to the UE(s) using the finite radio resources is needed.

In addition, due to the recent development of smart devices, a new method for efficiently transmitting/receiving a small amount of data or rarely occurring data is also required.

It will be appreciated by persons skilled in the art that the objects that could be achieved with the present invention are not limited to what has been particularly described hereinabove and the above and other objects that the present invention could achieve will be more clearly understood from the following detailed description.

### Technical Solutions

If the amount of downlink data for a UE, buffered by a network, exceeds a predetermined threshold, the network establishes user plane connection with the UE by changing a connection mode with the UE. Even when there is control plane connection capable of being used to transfer user data and the UE is reachable, the network does not transfer the DL data to the UE on the control plane connection and transfers the DL data to the UE after the U-plane connection is established.

According to an aspect of the present invention, provided herein is a method of changing a connection mode by a mobile management entity (MME) in a wireless communication system. The method may include receiving, from a serving gateway (S-GW), information indicating that an amount of downlink (DL) data for a user equipment (UE), buffered in the S-GW, exceeds a threshold; transmitting, to the S-GW, a mode change notification indicating that a connection mode with the UE, which is using a control plane connection for transferring user plane data, will be changed to a user plane; and requesting an eNode B (eNB) to set up a user plane connection with the UE.

In another aspect of the present invention, provided herein is a mobility management entity (MME) for changing a connection mode in a wireless communication system. The MME may include a transceiver, and a processor configured to control the transceiver. The processor may be configured to control the transceiver to receive, from a serving gateway (S-GW), information indicating that the amount of downlink (DL) data for a user equipment (UE), buffered in the S-GW, exceeds a threshold; control the transceiver to transmit, to the S-GW, a mode change notification indicating that a connection mode with the UE, which is using a control plane connection for transferring user plane data, will be changed to a user plane; and control the transceiver to request an eNode B (eNB) to set up a user plane connection with the UE.

In each aspect of the present invention, if the UE is in a power saving mode or an extended discontinuous reception (eDRX) state, the DL data may be buffered in the S-GW. In each aspect of the present invention, if the user plane connection is established, the DL data may be transmitted to the UE from the S-GW through the eNB on the user plane connection.

In each aspect of the present invention, uplink (UL) data or a UL signal may be received from the UE as a non-access stratum (NAS) message. When the control plane for transferring the user plane data is established with the S-GW, the UL data may be transmitted to the S-GW on the control plane connection

In each aspect of the present invention, if the mode change notification is transmitted to the S-GW, the DL data may not be received from the S-GW on the control plane connection.

In each aspect of the present invention, if the control plane connection for transferring the user plane data is not established with the S-GW, the mode change notification may be transmitted to the S-GW together with a setup request of the control plane connection.

In each aspect of the present invention, if the mode change notification is transmitted to the S-GW, the DL data may not be not received from the S-GW on the control plane connection

The above technical solutions are merely some parts of the embodiments of the present invention and various embodiments into which the technical features of the present invention are incorporated can be derived and understood by persons skilled in the art from the following detailed description of the present invention.

### Advantageous Effects

According to the present invention, radio communication signals can be efficiently transmitted/received. Therefore, overall throughput of a wireless communication system can be raised.

According to the present invention, a low-complexity and lost-cost UE can communicate with the network while maintaining backward compatibility with the legacy system.

According to an embodiment of the present invention, it is possible to implement a low-complexity and lost-cost UE.

According to an embodiment of the present invention, a UE can communicate with the network in a narrowband.

According to an embodiment of the present invention, it is possible to transmit/receive a small amount of data in an efficient manner.

According to an embodiment of the present invention, when a large amount of mobile-terminated (MT) data occurs, transmission efficiency can be raised and signaling overhead can be reduced.

It will be appreciated by persons skilled in the art that the effects that can be achieved through the present invention are not limited to what has been particularly described hereinabove and other advantages of the present invention will be more clearly understood from the following detailed description.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a diagram illustrating a brief structure of an EPS (evolved packet system) that includes an EPC (evolved packet core).

FIG. 2 is an exemplary diagram illustrating an architecture of a general E-UTRAN and a general EPC.

FIG. 3 is an exemplary diagram illustrating a structure of a radio interface protocol on a control plane.

FIG. 4 is an exemplary diagram illustrating a structure of a radio interface protocol on a user plane.

FIG. 5 is a diagram illustrating LTE protocol stacks for user and control planes.

FIG. 6 is a flow chart illustrating a random access procedure.

FIG. 7 is a diagram illustrating a connection procedure in a radio resource control (RRC) layer.

FIG. 8 is a diagram illustrating a UE triggered service request procedure.

FIG. 9 is a diagram illustrating in brief a data transmission procedure in accordance with Control Plane CIoT EPS optimization regarding radio signals.

FIG. 10 is a diagram illustrating an overall procedure for transferring data in an EPS system when Control Plane CIoT EPS optimization is used.

FIG. 11 is a diagram illustrating transferring mobile-terminated data in an EPS system according to Control Plane CIoT EPS optimization.

FIG. 12 illustrates problems caused by not performing mode/RAT change when a large amount of mobile terminated data is generated for a UE which is using control plane CIoT EPS optimization.

FIG. 13 illustrates mode/RAT change according to the present invention.

FIG. 14 is a diagram illustrating configurations of node devices according to a proposed embodiment.

### BEST MODE FOR CARRYING OUT THE INVENTION

Although the terms used in the present invention are selected from generally known and used terms, terms used herein may be varied depending on operator's intention or customs in the art, appearance of new technology, or the like. In addition, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

The following embodiments are proposed by combining constituent components and characteristics of the present invention according to a predetermined format. The individual constituent components or characteristics should be considered optional factors on the condition that there is no additional remark. If required, the individual constituent components or characteristics may not be combined with other components or characteristics. In addition, some constituent components and/or characteristics may be combined to implement the embodiments of the present invention. The order of operations to be disclosed in the embodiments of the present invention may be changed. Some components or characteristics of any embodiment may also be included in other embodiments, or may be replaced with those of the other embodiments as necessary.

In describing the present invention, if it is determined that the detailed description of a related known function or construction renders the scope of the present invention unnecessarily ambiguous, the detailed description thereof will be omitted.

In the entire specification, when a certain portion “comprises or includes” a certain component, this indicates that the other components are not excluded and may be further included unless specially described otherwise. The terms “unit”, “-or/er” and “module” described in the specification indicate a unit for processing at least one function or operation, which may be implemented by hardware, software or a combination thereof. The words “a or an”, “one”, “the” and words related thereto may be used to include both a singular expression and a plural expression unless the context describing the present invention (particularly, the context of the following claims) clearly indicates otherwise.

The embodiments of the present invention can be supported by the standard documents disclosed in any one of wireless access systems, such as an IEEE 802.xx system, a 3rd Generation Partnership Project (3GPP) system, a 3GPP Long Term Evolution (LTE)/LTE-Advanced (LTE-A) system, and a 3GPP2 system. That is, the steps or portions, which are not described in order to make the technical spirit of the present invention clear, may be supported by the above documents.

In addition, all the terms disclosed in the present document may be described by the above standard documents. In particular, the embodiments of the present invention may be supported by at least one of P802.16e-2004, P802.16e-2005, P802.16.1, P802.16p and P802.16.1 b documents, which are the standard documents of the IEEE 802.16 system.

Hereinafter, the preferred embodiments of the present invention will be described with reference to the accompanying drawings. It is to be understood that the detailed description which will be disclosed along with the accompanying drawings is intended to describe the exemplary embodiments of the present invention, and is not intended to describe a unique embodiment which the present invention can be carried out.

It should be noted that specific terms disclosed in the present invention are proposed for convenience of description and better understanding of the present invention, and the use of these specific terms may be changed to another format within the technical scope or spirit of the present invention.

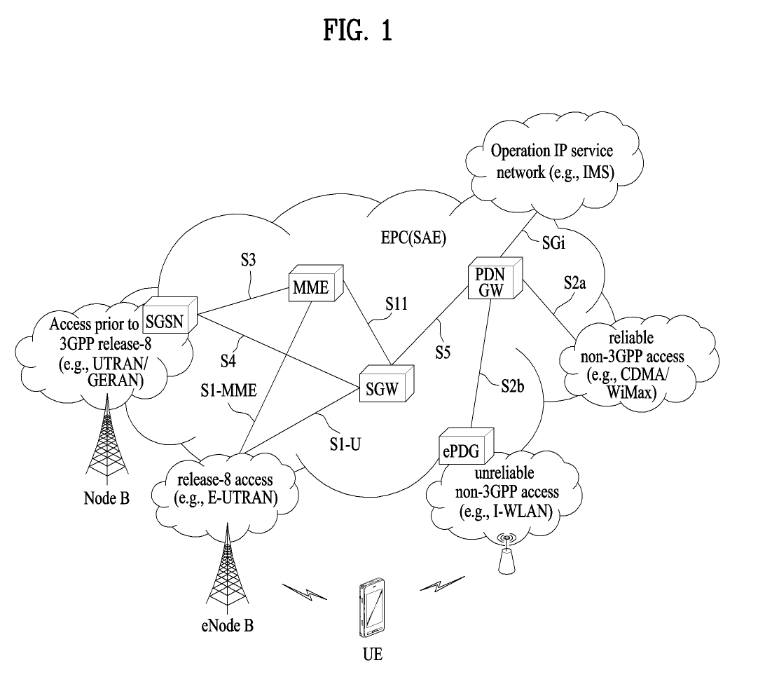

Terms used in the specification are defined as follows.
UMTS (Universal Mobile Telecommunications System): a GSM (Global System for Mobile Communication) based third generation mobile communication technology developed by the 3GPP.
EPS (Evolved Packet System): a network system that includes an EPC (Evolved Packet Core) which is an IP (Internet Protocol) based packet switched core network and an access network such as LTE and UTRAN. This system is the network of an evolved version of the UMTS.
NodeB: a base station of GERAN/UTRAN. This base station is installed outdoor and its coverage has a scale of a macro cell.
eNodeB: a base station of LTE. This base station is installed outdoor and its coverage has a scale of a macro cell.
UE (User Equipment): the UE may be referred to as terminal, ME (Mobile Equipment), MS (Mobile Station), etc. Also, the UE may be a portable device such as a notebook computer, a cellular phone, a PDA (Personal Digital Assistant), a smart phone, and a multimedia device. Alternatively, the UE may be a non-portable device such as a PC (Personal Computer) and a vehicle mounted device. The term “UE”, as used in relation to MTC, can refer to an MTC device.
HNB (Home NodeB): a base station of UMTS network. This base station is installed indoor and its coverage has a scale of a micro cell.
HeNB (Home eNodeB): a base station of an EPS network. This base station is installed indoor and its coverage has a scale of a micro cell.
MME (Mobility Management Entity): a network node of an EPS network, which performs mobility management (MM) and session management (SM).
PDN-GW (Packet Data Network-Gateway)/PGW/P-GW: a network node of an EPS network, which performs UE IP address allocation, packet screening and filtering, charging data collection, etc.
SGW (Serving Gateway/S-GW: a network node of an EPS network, which performs mobility anchor, packet routing, idle-mode packet buffering, and triggering of an MME's UE paging.
PCRF (Policy and Charging Rule Function): a network node of an EPS network, which performs a policy decision to dynamically apply different QoS and charging policies for each service flow.
OMA DM (Open Mobile Alliance Device Management): a protocol designed to manage mobile devices such as a cell phone, a PDA, and a laptop computer, which performs functions such as device configuration, firmware upgrade, error report, and the like.
OAM (Operation Administration and Maintenance): a set of network management functions, which provides network error display, performance information, data, and management functions.
NAS (Non-Access Stratum): a higher stratum of a control plane between a UE and MME. As a functional layer for exchanging signaling and traffic messages between a UE and core network in LTE/UMTS protocol stack, the NAS supports UE mobility, a session management procedure for establishing and maintaining an IP connection between a UE and PDN GW, and IP address management.
EMM (EPS Mobility Management): as a sub layer of the NAS layer, the EMM may be in either “EMM-Registered” state or “EMM-Deregistered” state depending on whether a UE is attached or detached to the network.
ECM (EMM Connection Management) connection: a signaling connection for exchanging NAS messages, which is established between a UE and an MME. The ECM connection is a logical connection configured with an RRC connection between a UE and an eNB and an S1 signaling connection between the eNB and an MME. When the ECM connection is established/terminated, the RRC and S1 signaling connections are established/terminated. The establishment of the ECM connection means that the UE establishes the RRC connection with the eNB and the MME establishes the S1 signaling connection with the eNB. Depending on whether the NAS signaling connection, that is, ECM connection is established, an ECM may be in either “ECM-Connected” state or “ECM-Idle” state.
AS (Access-Stratum): the AS includes a protocol stack between a UE and a radio (or access) network, which manages transmission of data and network control signals.
NAS configuration MO (Management Object): the NAS configuration MO is a management object (MO) used to configure parameters related to NAS functionality for a UE.
PDN (Packet Data Network): a network in which a server supporting a specific service (e.g., a Multimedia Messaging Service (MMS) server, a Wireless Application Protocol (WAP) server, etc.) is located.
PDN connection: a logical connection between a UE and a PDN, represented as one IP address (one IPv4 address and/or one IPv6 prefix).
APN (Access Point Name): a character string for indicating or identifying PDN. To access a requested service or network, a connection to a specific P-GW is required. The APN means a name (character string) predefined in a network to search for the corresponding P-GW (for example, it may be defined as internet.mnc012.mcc345.gprs).
RAN (Radio Access Network): a unit including a Node B, an eNode B, and a Radio Network Controller (RNC) for controlling the Node B and the eNode B in a 3GPP network, which is present between UEs and provides a connection to a core network.
HLR (Home Location Register)/HSS (Home Subscriber Server): a database having subscriber information in a 3GPP network. The HSS can perform functions such as configuration storage, identity management, and user state storage.
PLMN (Public Land Mobile Network): a network configured for the purpose of providing mobile communication services to individuals. This network can be configured per operator.
ANDSF (Access Network Discovery and Selection Function): This is one of network entities for providing a policy for discovering and selecting an access that can be used by a UE on an operator basis.
EPC Path (or Infrastructure Data Path): A user plane communication path through an EPC.
E-RAB (E-UTRAN Radio Access Bearer): A concatenation of an S1 bearer and a corresponding data radio bearer. When there is an E-RAB, the E-RAB is in a one-to-one mapping relationship with an EPS bearer for the NAS.
GTP (GPRS Tunneling Protocol): A group of IP-based communication protocols, which is used for carrying general packet radio services (GPRSs) in GSM, UMTS, and LTE networks. In the 3GPP architecture, GTP and proxy mobile IPv6 based interfaces are specified on various interface points. The GTP may be decomposed to several protocols (e.g., GTP-C, GTP-U, GPT′, etc.). The GTP-C is used by a GPRS core network for the purpose of signaling between gateway GPRS support nodes (GGSNs) and serving GPRS support nodes (SGSNs). In addition, the GTP-C allows the SGSN to activate a session for a user (e.g., activation of a PDN context), deactivate the same session, adjust the quality of service parameters, or update the session for a subscriber operating in another SGSN. The GPT-U is used for carrying user data in the GPRS core network and between a radio access network and a core network. FIG. 1 is a schematic diagram showing the structure of an evolved packet system (EPS) including an evolved packet core (EPC).

The EPC is a core element of system architecture evolution (SAE) for improving performance of 3GPP technology. SAE corresponds to a research project for determining a network structure supporting mobility between various types of networks. For example, SAE aims to provide an optimized packet-based system for supporting various radio access technologies and providing an enhanced data transmission capability.

Specifically, the EPC is a core network of an IP mobile communication system for 3GPP LTE and can support real-time and non-real-time packet-based services. In conventional mobile communication systems (i.e. second-generation or third-generation mobile communication systems), functions of a core network are implemented through a circuit-switched (CS) sub-domain for voice and a packet-switched (PS) sub-domain for data. However, in a 3GPP LTE system which is evolved from the third generation communication system, CS and PS sub-domains are unified into one IP domain. That is, in 3GPP LTE, connection of terminals having IP capability can be established through an IP-based business station (e.g., an eNodeB (evolved Node B)), EPC, and an application domain (e.g., IMS). That is, the EPC is an essential structure for end-to-end IP services.

The EPC may include various components. FIG. 1 shows some of the components, namely, a serving gateway (SGW), a packet data network gateway (PDN GW), a mobility management entity (MME), a serving GPRS (general packet radio service) supporting node (SGSN) and an enhanced packet data gateway (ePDG).

The SGW operates as a boundary point between a radio access network (RAN) and a core network and maintains a data path between an eNodeB and the PDN GW. When. When a terminal moves over an area served by an eNodeB, the SGW functions as a local mobility anchor point. That is, packets. That is, packets may be routed through the SGW for mobility in an evolved UMTS terrestrial radio access network (E-UTRAN) defined after 3GPP release-8. In addition, the SGW may serve as an anchor point for mobility of another 3GPP network (a RAN defined before 3GPP release-8, e.g., UTRAN or GERAN (global system for mobile communication (GSM)/enhanced data rates for global evolution (EDGE) radio access network).

The PDN GW corresponds to a termination point of a data interface for a packet data network. The PDN GW may support policy enforcement features, packet filtering and charging support. In addition, the PDN GW may serve as an anchor point for mobility management with a 3GPP network and a non-3GPP network (e.g., an unreliable network such as an interworking wireless local area network (I-WLAN) and a reliable network such as a code division multiple access (CDMA) or WiMax network).

Although the SGW and the PDN GW are configured as separate gateways in the example of the network structure of FIG. 1, the two gateways may be implemented according to a single gateway configuration option.

The MME performs signaling and control functions for supporting access of a UE for network connection, network resource allocation, tracking, paging, roaming and handover. The MME controls control plane functions associated with subscriber and session management. The MME manages numerous eNodeBs and signaling for selection of a conventional gateway for handover to other 2G/3G networks. In addition, the MME performs security procedures, terminal-to-network session handling, idle terminal location management, etc.

The SGSN handles all packet data such as mobility management and authentication of a user for other 3GPP networks (e.g., a GPRS network).

The ePDG serves as a security node for a non-3GPP network (e.g., an I-WEAN, a Wi-Fi hotspot, etc.).

As described above with reference to FIG. 1, a terminal having IP capabilities may access an IP service network (e.g., an IMS) provided by an operator via various elements in the EPC not only based on 3GPP access but also on non-3GPP access.

Additionally, FIG. 1 shows various reference points (e.g. S1-U, S1-MME, etc.). In 3GPP, a conceptual link connecting two functions of different functional entities of an E-UTRAN and an EPC is defined as a reference point. Table 1 is a list of the reference points shown in FIG. 1. Various reference points may be present in addition to the reference points in Table 1 according to network structures.

TABLE 1

| Reference | |
|---|---|
| point | Description |
| S1-MME | Reference point for the control plane protocol between E-UTRAN and MME |
| S1-U | Reference point between E-UTRAN and Serving GW for the per bearer user plane |
| | tunneling and inter eNodeB path switching during handover |
| S3 | It enables user and bearer information exchange for inter 3GPP access network |
| | mobility in idle and/or active state. This reference point can be used intra-PLMN or |
| | inter-PLMN (e.g. in the case of Inter-PLMN HO). |
| S4 | It provides related control and mobility support between GPRS Core and the 3GPP |
| | Anchor function of Serving GW. In addition, if Direct Tunnel is not established, it |
| | provides the user plane tunneling. |
| S5 | It provides user plane tunneling and tunnel management between Serving GW and |
| | PDN GW. It is used for Serving GW relocation due to UE mobility and if the |
| | Serving GW needs to connect to a non-collocated PDN GW for the required PDN |
| | connectivity. |
| S11 | Reference point between an MME and an SGW |
| SGi | It is the reference point between the PDN GW and the packet data network. Packet |
| | data network may be an operator external public or private packet data network or |
| | an intra operator packet data network, e.g. for provision of IMS services. This |
| | reference point corresponds to Gi for 3GPP accesses. |

Among the reference points shown in FIG. 1, S2a and S2b correspond to non-3GPP interfaces. S2a is a reference point which provides reliable non-3GPP access and related control and mobility support between PDN GWs to a user plane. S2b is a reference point which provides related control and mobility support between the ePDG and the PDN GW to the user plane.

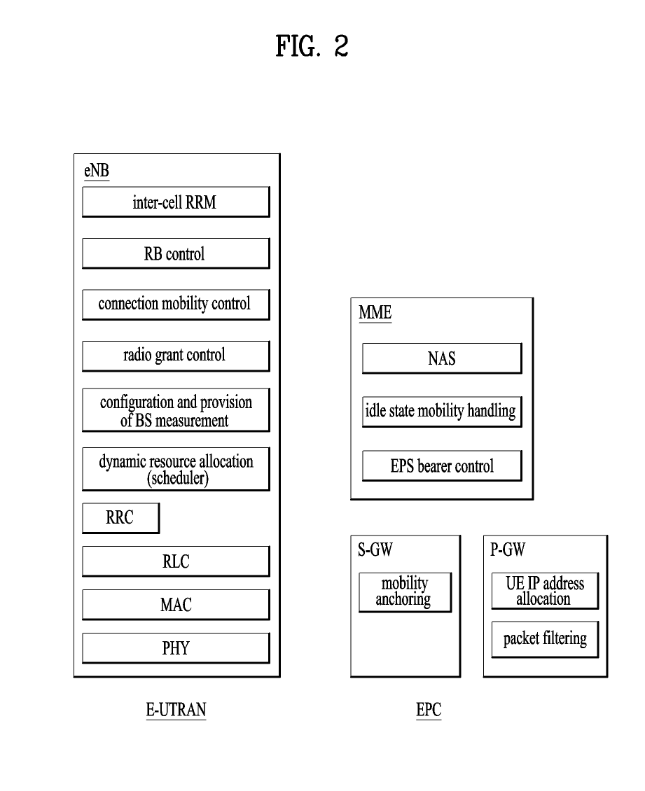

FIG. 2 is a diagram exemplarily illustrating architectures of a typical E-UTRAN and EPC.

As shown in the figure, while radio resource control (RRC) connection is activated, an eNodeB may perform routing to a gateway, scheduling transmission of a paging message, scheduling and transmission of a broadcast channel (BCH), dynamic allocation of resources to a UE on uplink and downlink, configuration and provision of eNodeB measurement, radio bearer control, radio admission control, and connection mobility control. In the EPC, paging generation, LTE_IDLE state management, ciphering of the user plane, SAE bearer control, and ciphering and integrity protection of NAS signaling.

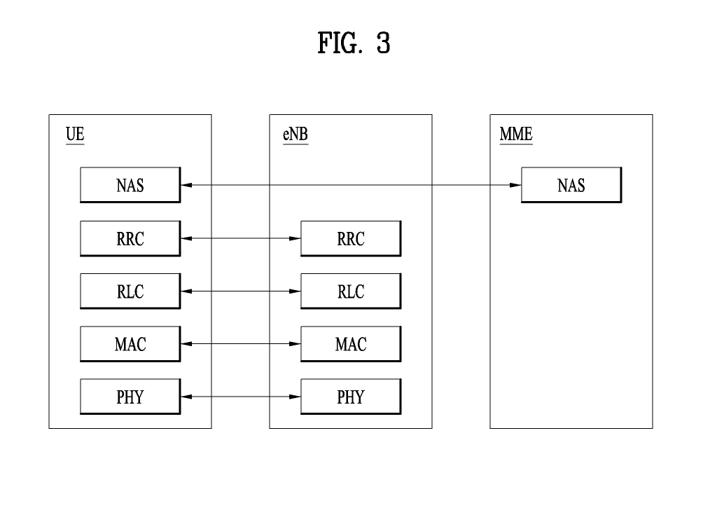

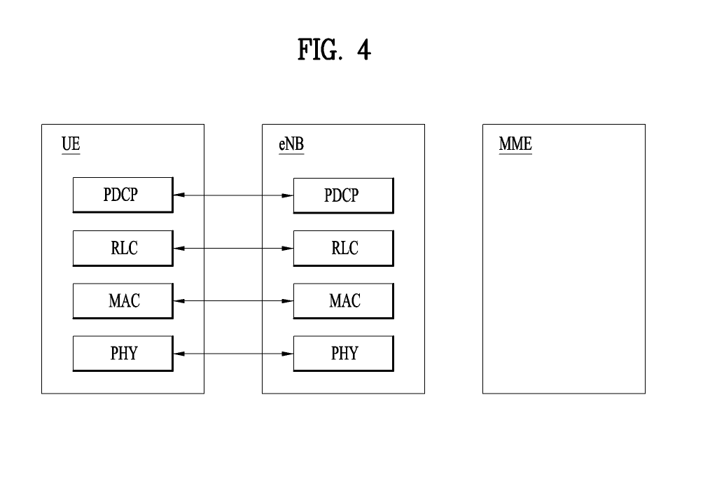

FIG. 3 is a diagram exemplarily illustrating the structure of a radio interface protocol in a control plane between a UE and a base station, and FIG. 4 is a diagram exemplarily illustrating the structure of a radio interface protocol in a user plane between the UE and the base station.

The radio interface protocol is based on the 3GPP wireless access network standard. The radio interface protocol horizontally includes a physical layer, a data link layer, and a networking layer. The radio interface protocol is divided into a user plane for transmission of data information and a control plane for delivering control signaling, which are arranged vertically.

The protocol layers may be classified into a first layer (L1), a second layer (L2), and a third layer (L3) based on the three sublayers of the open system interconnection (OSI) model that is well known in the communication system.

Hereinafter, description will be given of a radio protocol in the control plane shown in FIG. 3 and a radio protocol in the user plane shown in FIG. 4.

The physical layer, which is the first layer, provides an information transfer service using a physical channel. The physical channel layer is connected to a medium access control (MAC) layer, which is a higher layer of the physical layer, through a transport channel. Data is transferred between the physical layer and the MAC layer through the transport channel. Transfer of data between different physical layers, i.e., a physical layer of a transmitter and a physical layer of a receiver is performed through the physical channel.

The physical channel consists of a plurality of subframes in the time domain and a plurality of subcarriers in the frequency domain. One subframe consists of a plurality of OFDM symbols in the time domain and a plurality of subcarriers. One subframe consists of a plurality of resource blocks. One resource block consists of a plurality of OFDM symbols and a plurality of subcarriers. A Transmission Time Interval (TTI), a unit time for data transmission, is 1 ms, which corresponds to one subframe.

According to 3GPP LTE, the physical channels present in the physical layers of the transmitter and the receiver may be divided into data channels corresponding to Physical Downlink Shared Channel (PDCCH) and Physical Uplink Shared Channel (PUSCH) and control channels corresponding to Physical Downlink Control Channel (PDCCH), Physical Control Format Indicator Channel (PCFICH), Physical Hybrid-ARQ Indicator Channel (PHICH) and Physical Uplink Control Channel (PUCCH).

The second layer includes various layers. First, the MAC layer in the second layer serves to map various logical channels to various transport channels and also serves to map various logical channels to one transport channel. The MAC layer is connected with an RLC layer, which is a higher layer, through a logical channel. The logical channel is broadly divided into a control channel for transmission of information of the control plane and a traffic channel for transmission of information of the user plane according to the types of transmitted information.

The radio link control (RLC) layer in the second layer serves to segment and concatenate data received from a higher layer to adjust the size of data such that the size is suitable for a lower layer to transmit the data in a radio interval.

The Packet Data Convergence Protocol (PDCP) layer in the second layer performs a header compression function of reducing the size of an IP packet header which has a relatively large size and contains unnecessary control information, in order to efficiently transmit an IP packet such as an IPv4 or IPv6 packet in a radio interval having a narrow bandwidth. In addition, in LIE, the PDCP layer also performs a security function, which consists of ciphering for preventing a third party from monitoring data and integrity protection for preventing data manipulation by a third party.

The Radio Resource Control (RRC) layer, which is located at the uppermost part of the third layer, is defined only in the control plane, and serves to configure radio bearers (RBs) and control a logical channel, a transport channel, and a physical channel in relation to reconfiguration and release operations. The RB represents a service provided by the second layer to ensure data transfer between a UE and the E-UTRAN.

If an RRC connection is established between the RRC layer of the UE and the RRC layer of a wireless network, the UE is in the RRC Connected mode. Otherwise, the UE is in the RRC_Idle mode.

Hereinafter, description will be given of the RRC state of the UE and an RRC connection method. The RRC state refers to a state in which the RRC of the UE is or is not logically connected with the RRC of the E-UTRAN. The RRC state of the UE having logical connection with the RRC of the E-UTRAN is referred to as an RRC_CONNECTED state. The RRC state of the UE which does not have logical connection with the RRC of the E-UTRAN is referred to as an RRC_IDLE state. A UE in the RRC_CONNECTED state has RRC connection, and thus the E-UTRAN may recognize presence of the UE in a cell unit. Accordingly, the UE may be efficiently controlled. On the other hand, the E-UTRAN cannot recognize presence of a UE which is in the RRC_IDLE state. The UE in the RRC_IDLE state is managed by a core network in a tracking area (TA) which is an area unit larger than the cell. That is, for the UE in the RRC_IDLE state, only presence or absence of the UE is recognized in an area unit larger than the cell. In order for the UE in the RRC_IDLE state to be provided with a usual mobile communication service such as a voice service and a data service, the UE should transition to the RRC_CONNECTED state. A TA is distinguished from another TA by a tracking area identity (TAI) thereof. A UE may configure the TAI through a tracking area code (TAC), which is information broadcast from a cell.

When the user initially turns on the UE, the UE searches for a proper cell first. Then, the UE establishes RRC connection in the cell and registers information thereabout in the core network. Thereafter, the UE stays in the RRC_IDLE state. When necessary, the UE staying in the RRC_IDLE state selects a cell (again) and checks system information or paging information. This operation is called camping on a cell. Only when the UE staying in the RRC_IDLE state needs to establish RRC connection, does the UE establish RRC connection with the RRC layer of the E-UTRAN through the RRC connection procedure and transition to the RRC_CONNECTED state. The UE staying in the RRC_IDLE state needs to establish RRC connection in many cases. For example, the cases may include an attempt of a user to make a phone call, an attempt to transmit data, or transmission of a response message after reception of a paging message from the E-UTRAN.

The non-access stratum (NAS) layer positioned over the RRC layer performs functions such as session management and mobility management.

Hereinafter, the NAS layer shown in FIG. 3 will be described in detail.

The ESM (evolved Session Management) belonging to the NAS layer performs functions such as default bearer management and dedicated bearer management to control a UE to use a PS service from a network. The UE is assigned a default bearer resource by a specific packet data network (PDN) when the UE initially accesses the PDN. In this case, the network allocates an available IP to the UE to allow the UE to use a data service. The network also allocates QoS of a default bearer to the UE. LTE supports two kinds of bearers. One bearer is a bearer having characteristics of guaranteed bit rate (GBR) QoS for guaranteeing a specific bandwidth for transmission and reception of data, and the other bearer is a non-GBR bearer which has characteristics of best effort QoS without guaranteeing a bandwidth. The default bearer is assigned to a non-GBR bearer. The dedicated bearer may be assigned a bearer having QoS characteristics of GBR or non-GBR.

A bearer allocated to the UE by the network is referred to as an evolved packet service (EPS) bearer. When the EPS bearer is allocated to the UE, the network assigns one ID. This ID is called an EPS bearer ID. One EPS bearer has QoS characteristics of a maximum bit rate (MBR) and/or a guaranteed bit rate (GBR).

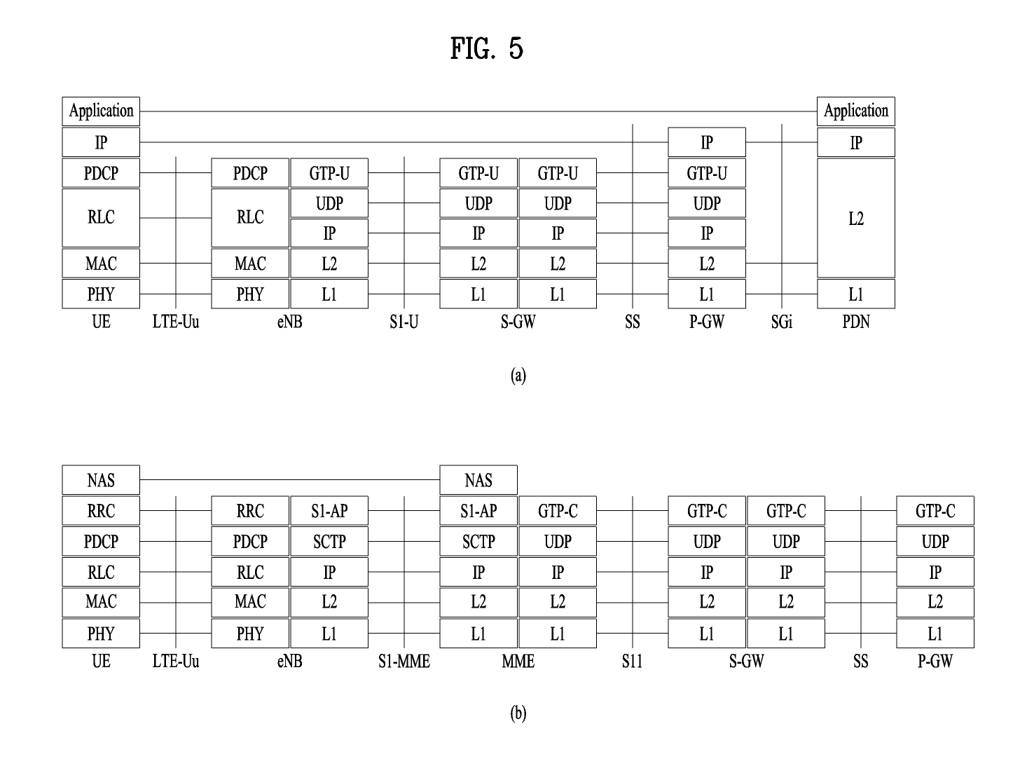

FIG. 5 is a diagram illustrating LTE protocol stacks for user and control planes. Specifically, FIG. 5(a) illustrates user plane protocol stacks between a UE, eNB. SGW, PGW, and PDN, and FIG. 5(b) illustrates control plane protocol stacks between a UE, eNB, MME, SGW, and PGW. Hereinafter, a description will be given of functions of key layers of the protocol stacks.

Referring to FIG. 5(a), a GTP-U protocol is used to forward user IP packets over S1-U/S5 interfaces. If a GTP tunnel is established for data forwarding during LIE handover. End Marker Packet is transferred as the last pack through the GTP tunnel.

Referring to FIG. 5 (b), an S1 AP protocol is applied to an S1-MME interface. The S1AP protocol supports functions such as S1 interface management, E-RAB management, NAS signaling transmission, and UE context management. The S1AP protocol transfers an initial UE context to an eNB to set up an E-RAB(s) and then manages modification or release of the UE context. A GTP-C protocol is applied to S11/S5 interfaces. The GTP-C protocol supports the exchange of control information for generation, modification and termination of a GTP tunnel(s). In the case of the LTE handover, the GTP-C protocol generates forwarding tunnels.

The details of the protocol stacks and interfaces in FIGS. 3 and 4 can be applied to the same protocol stacks and interfaces in FIG. 5.

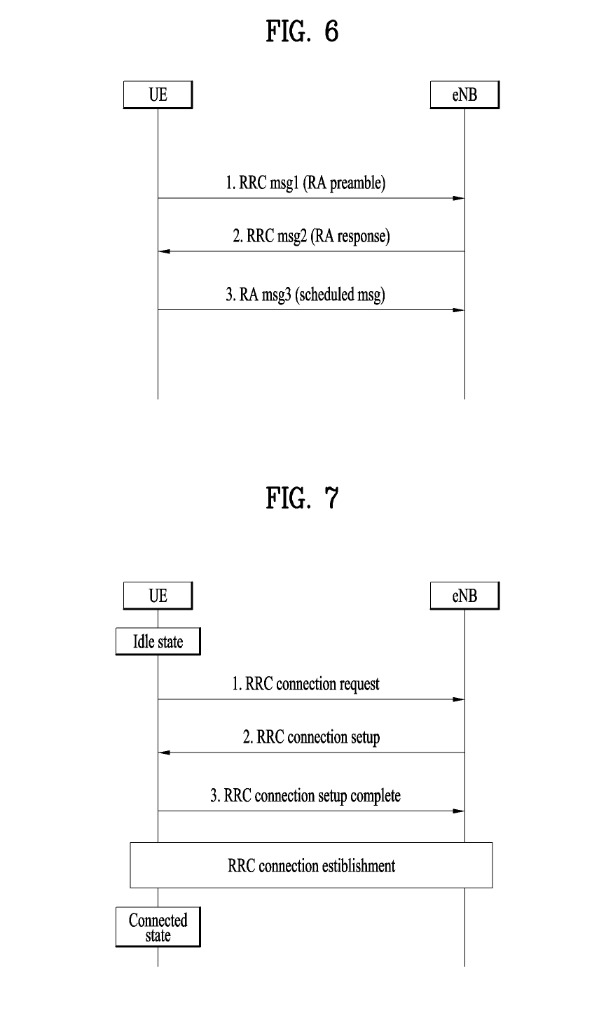

FIG. 6 is a flowchart illustrating a random access procedure in 3GPP LTE.

The random access procedure is performed for a UE to obtain UL synchronization with an eNB or to be assigned a UL radio resource.

The UE receives a root index and a physical random access channel (PRACH) configuration index from an eNodeB. Each cell has 64 candidate random access preambles defined by a Zadoff-Chu (ZC) sequence. The root index is a logical index used for the UE to generate 64 candidate random access preambles.

Transmission of a random access preamble is limited to a specific time and frequency resources for each cell. The PRACH configuration index indicates a specific subframe and preamble format in which transmission of the random access preamble is possible.

The random access procedure, particularly, contention-based random access procedure includes the following three steps. The messages transmitted in step 1, 2 and 3 can be referred to as msg1, msg2 and msg3.

1. The UE transmits a randomly selected random access preamble to the eNodeB. The UE selects a random access preamble from among 64 candidate random access preambles and the UE selects a subframe corresponding to the PRACH configuration index. The UE transmits the selected random access preamble in the selected subframe.

2. Upon receiving the random access preamble, the eNodeB sends a random access response (RAR) to the UE. The RAR is detected in two steps. First, the UE detects a PDCCH masked with a random access (RA)-RNTI. The UE receives an RAR in a MAC (medium access control) PDU (protocol data unit) on a PDSCH indicated by the detected PDCCH. The RAR includes timing advance (TA) information indicating timing offset information for UL synchronization, UL resource allocation information (UL grant information), and temporary UE identifier (e.g., temporary cell-RNTI, TC-RNTI, etc.).

3. The UE can perform UL transmission according to the resource allocation information (i.e., scheduling information) and TA value included in the RAR. HARQ is applied to the UL transmission corresponding to the RAR. Thus, after performing the UL transmission, the UE may receive reception response information (e.g., PHICH) in response to the UL transmission.

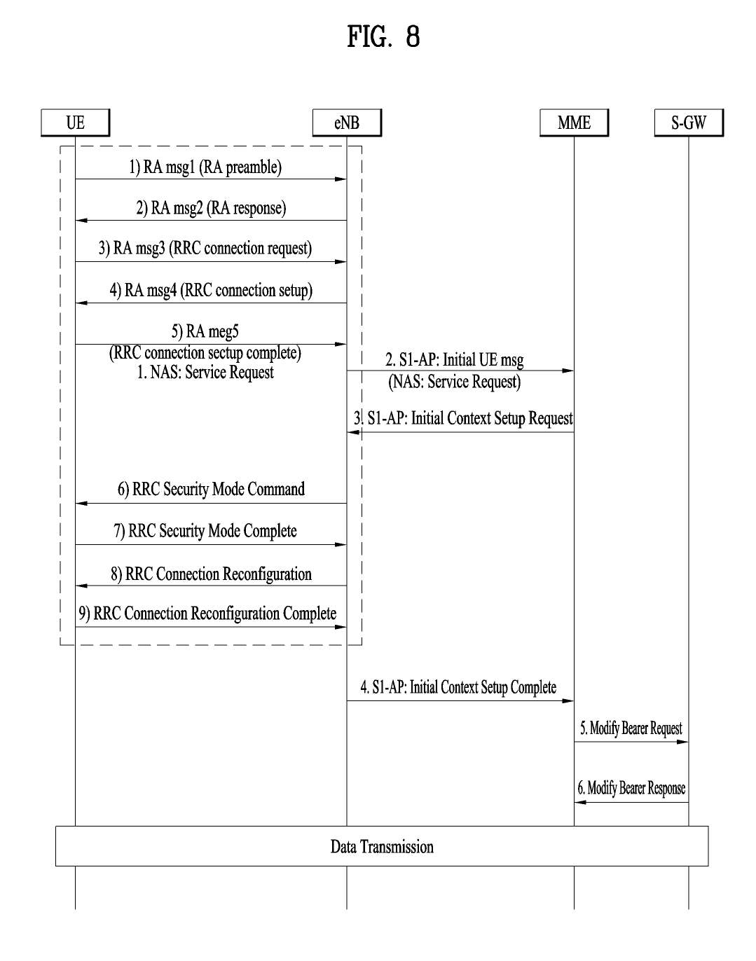

FIG. 7 illustrates a connection procedure in a radio resource control (RRC) layer.

As shown in FIG. 7, the RRC state is set according to whether or not RRC connection is established. An RRC state indicates whether or not an entity of the RRC layer of a UE has logical connection with an entity of the RRC layer of an eNodeB. An RRC state in which the entity of the RRC layer of the UE is logically connected with the entity of the RRC layer of the eNodeB is called an RRC connected state. An RRC state in which the entity of the RRC layer of the UE is not logically connected with the entity of the RRC layer of the eNodeB is called an RRC_idle state.

A UE in the connected state has RRC connection, and thus the E-UTRAN may recognize presence of the UE in a cell unit. Accordingly, the UE may be efficiently controlled. On the other hand, the E-UTRAN cannot recognize presence of a UE which is in the idle state. The UE in the idle state is managed by the core network in a tracking area unit which is an area unit larger than the cell. The tracking area is a unit of a set of cells. That is, for the UE which is in the idle state, only presence or absence of the UE is recognized in a larger area unit. In order for the UE in the idle state to be provided with a usual mobile communication service such as a voice service and a data service, the UE should transition to the connected state.

When the user initially turns on the UE, the UE searches for a proper cell first, and then stays in the idle state. Only when the UE staying in the idle state needs to establish RRC connection, the UE establishes RRC connection with the RRC layer of the eNodeB through the RRC connection procedure and then performs transition to the RRC connected state.

The UE staying in the idle state needs to establish RRC connection in many cases. For example, the cases may include an attempt of a user to make a phone call, an attempt to transmit data, or transmission of a response message after reception of a paging message from the E-UTRAN.

In order for the UE in the idle state to establish RRC connection with the eNodeB, the RRC connection procedure needs to be performed as described above. The RRC connection procedure is broadly divided into transmission of an RRC connection request message from the UE to the eNodeB, transmission of an RRC connection setup message from the eNodeB to the UE, and transmission of an RRC connection setup complete message from the UE to eNodeB, which are described in detail below with reference to FIG. 7.

1. When the UE in the idle state desires to establish RRC connection for reasons such as an attempt to make a call, a data transmission attempt, or a response of the eNodeB to paging, the UE transmits an RRC connection request message to the eNodeB first.

2. Upon receiving the RRC connection request message from the UE, the ENB accepts the RRC connection request of the UE when the radio resources are sufficient, and then transmits an RRC connection setup message, which is a response message, to the UE.

3. Upon receiving the RRC connection setup message, the UE transmits an RRC connection setup complete message to the eNodeB.

Only when the UE successfully transmits the RRC connection setup message, does the UE establish RRC connection with the eNodeB and transition to the RRC connected mode.

When new traffic occurs, the UE staying in the idle state performs a service request procedure to transition to an activate state where the UE can transmit/receive traffic. When an S1 connection is released and radio resources are not allocated due to traffic deactivation although the UE is registered in the network, that is, when the UE is in the EMM-Registered state and the ECM-Idle state, if there occurs traffic which the UE needs to transmit or the network needs to transmit to the UE, the UE may send a request for the service to the network. When the UE successfully completes the service request procedure, the UE transitions to the ECM-Connected state and then performs transmission/reception by establishing an ECM connection (i.e., RRC connection+S1 signaling connection) in the control plane and an E-RAB (i.e., DRB and S1 bearer) in the user plane. When the network desires to transmit traffic to a UE in the ECM-Idle state, the network transmits a Paging message to the UE to inform that there is traffic to be transmitted. By doing so, the UE may perform the service request procedure.

A network triggered service request procedure will now be described in brief. If an MME has or needs to transmit DL data or signals to an UE in the ECM-IDLE state, for example, if the MME needs to perform the MME/HSS-initiated detach procedure for the ECM-IDLE mode UE or an S-GW receives control signaling (e.g. Create Bearer Request or Modify Bearer Request), the MME starts the network triggered service request procedure. When the S-GW receives Create Bearer Request or Modify Bearer Request for the UE in the state that ISR is activated, the S-GW does not have a DL S1-U. If an SGSN has notified the S-GW that the UE has moved to a PMM-IDLE or STANDBY state, the S-GW buffers signaling messages and transmits Downlink Data Notification to trigger the MME and SGSN to page the UE. If the S-GW is triggered to send a second Downlink Data Notification message for a bearer with priority (i.e. ARP priority level) higher than priority of a bearer for which a first Downlink Data Notification message has been sent while waiting for the user plane to be established, the S-GW sends a new Downlink Data Notification message indicating the higher priority to the MME. If the S-GW receives additional DL data packets for a bearer with priority identical to or higher than priority of a bearer for which the first Downlink Data Notification message has been sent, or if after sending the second Downlink Data Notification message indicating the higher priority, the S-GW receives additional DL data packets for the UE, the S-GW buffers these DL data packets and does not send the new Downlink Data Notification message. The S-GW will be notified about a current RAT type based on a UE triggered service request procedure. In addition, the S-GW will keep executing a dedicated bearer activation or dedicated bearer modification procedure. That is, the S-GW will send corresponding buffered signaling to the MME or SGSN where the UE currently resides and inform a P-GW of the current RAT type if a RAT type has been changed compared to the last reported RAT type. If dynamic PCC is deployed, information about the current RAT type is conveyed from the P-GW to a PCRF. If the PCRF leads to EPS bearer modification as a response, the P-GW initiates a bearer update procedure. When sending the Downlink Data Notification message, the S-GW includes both an EPS bearer ID and ARP. If the Downlink Data Notification message is triggered by the arrival of DL data packets at the S-GW, the S-GW includes the EPS bearer ID and ARP associated with the bearer through which the DL data packet has been received. If the Downlink Data Notification message is triggered by the arrival of control signaling and if the EPS bearer ID and ARP are present in the control signaling, the S-GW includes the corresponding EPS bearer ID and ARP. If the ARP is not present in the control signaling, the S-GW includes the ARP in a stored EPS bearer context. When an L-GW receives DL data for a UE in the ECM-IDLE state, if an LIPA PDN connection exists, the L-GW sends the first DL user packet to the S-GW and buffers all other DL user packets. The S-GW triggers the MME to page the UE. Details of the network triggered service request procedure can be found in section 5.3.4.3 of 3GPP TS 23.401.

FIG. 8 is a diagram illustrating a UE triggered service request procedure.

Referring to FIG. 8, when there is traffic to be transmitted, a UE transmits an RRC Connection Request message to an eNB during a random access procedure, that is, by performing steps 1) to 3). When the eNB accepts the RRC connection request from the UE, the eNB transmits an RRC Connection Setup message to the UE. Upon receiving the RRC Connection Setup message, the UE transmits an RRC Connection Setup Complete message to the eNB by including a service request in the message. This will be described in detail with respect to a service request between a UE and MME.

1. The UE sends NAS message Service Request to be transmitted to an MME by encapsulating it in an RRC message (e.g., RA msg5 in FIG. 8) toward the eNB.

2. The eNB forwards the NAS message to the MME. The NAS message is encapsulated in S1-AP.

3. The MME transmits an S1-Ap Initial Context Setup Request message to the eNB. In this step, radio and S1 bearers are activated for all activate EPS bearers. The eNB stores a security context, MME signaling connection ID, EPS bearer QoS(s), etc. in a UE context.

The eNB performs a radio bearer establishment procedure. Here, the radio bearer establishment procedure includes steps 6) to 9) illustrated in FIG. 8.

4. The eNB transmits S1-AP message Initial Context Setup Complete to the MME.

5. The MME transmits a Modify Bearer Request message for each PDN connection to an S-GW.

6. The S-GW returns Modify Bearer Response to the MME in response to the Modify Bearer Request message.

Thereafter, traffic is transmitted/received via the E-RAB established by the service request procedure.

Recently, machine type communication (MTC) has come to the fore as a significant communication standard issue. MTC refers to exchange of information between a machine and an eNB without involving persons or with minimal human intervention. For example, MTC may be used for data communication for measurement/sensing/reporting such as meter reading, water level measurement, use of a surveillance camera, inventory reporting of a vending machine, etc. and may also be used for automatic application or firmware update processes for a plurality of UEs that share predetermined characteristics. In MTC, the amount of transmission data is small and data transmission or reception (hereinafter, transmission/reception) occurs occasionally. That is, in the case of a UE for MTC (hereinafter referred to as an MTC UE), it is efficient to reduce production cost and battery consumption according to the low data transfer rate due to such MTC features. Since the MTC LIE has low mobility, the channel environment thereof remains substantially the same. If an MTC UE is used for metering, reading of a meter, surveillance, and the like, the MTC UE is very likely to be located in a place such as a basement, a warehouse, and mountain regions which the coverage of a typical eNB does not reach. Considering the purposes of the MTC UE, it is preferred to allow a signal for the MTC UE to have wider coverage than a signal for the conventional UE (hereinafter, a legacy UE).

It is expected that a number of devices will be wirelessly connected to each other through the Internet of Things (IoT). The IoT means internetworking of physical devices, vehicles, connected devices, smart devices, buildings, and other items with electronics, software, sensors, actuators, and network connectivity that enable these objects to collect and exchange data. In other words, the IoT refers to a network of physical objects, machines, people, and other devices that enable connectivity and communication for the purpose of exchanging data for intelligent applications and services. The IoT allows objects to be sensed and controlled remotely through existing network infrastructures, thereby providing opportunities for the direct integration between the physical and digital worlds, which result in improving efficiency, accuracy and economic benefits. Particularly, in the present invention, the IoT using the 3GPP technology is referred to as cellular IoT (CIoT). In addition, the CIoT that transmits/receives IoT signals using a narrowband (e.g., a frequency band of about 200 kHz) is called NB-IoT.

The CIoT is used to monitor traffic transmitted over a relatively long period, e.g., from a few decades to a year (e.g., smoke alarm detection, power failure notification from smart meters, tamper notification, smart utility (gas/water/electricity) metering reports, software patches/updates, etc.) and support ‘IoT’ devices characterized as ultra-low complexity, power limitation and low data rates.

According to the prior art, a UE in the EMM-Idle state should establish a connection with the network to transmit data. To this end, the UE should successfully complete the service request procedure illustrated in FIG. 8, but it is not suitable for the CIoT that requires optimized power consumption for the low data rate. To transmit data to an application, two types of optimization: user plane CIoT EPS optimization and Control Plane CIoT EPS optimization has been defined for the CIoT in the EPS.

User plane CIoT EPS optimization and control plane CIoT EPS optimization may also be called a U-plane solution and a C-plane solution, respectively.

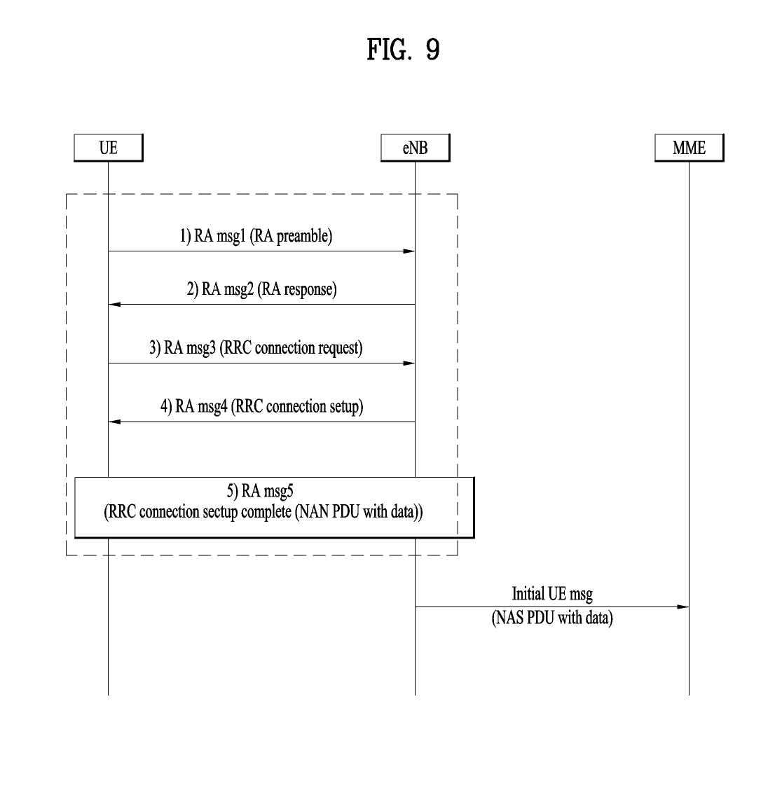

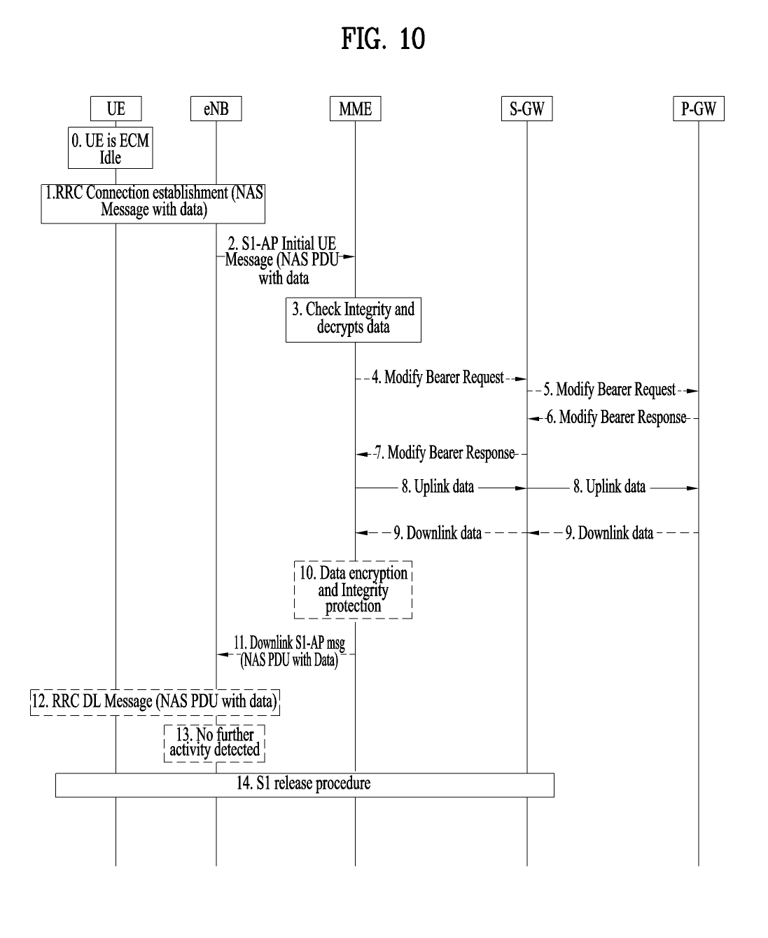

FIG. 9 is a diagram illustrating in brief a data transmission procedure in accordance with Control Plane CIoT EPS optimization regarding radio signals.

According to the Control Plane CIoT EPS optimization, UL data is transferred from an eNB (CIoT RAN) to an MME. Thereafter, the UL data may be transmitted from the MME to a P-GW through an S-GW. Through these nodes, the UL data is forwarded to an application server (i.e., CIoT services). DL data is transmitted through the same path in the opposite direction. In the case of a Control Plane CIoT EPS optimization solution, there is no setup data radio bearer, but data packets are transmitted through signaling bearers. Thus, this solution is most suitable for transmission of infrequent small data packets.

When a UE and MME use the Control Plane CIoT EPS optimization is applied, the UE and MME may transfer IP or non-IP data through NAS signaling depending on data types selected for a PDN connection supported at PDN connection establishment.

The Control Plane CIoT EPS optimization can be achieved by using NAS transport capabilities of RRC and S1-AP protocols and data transfer through GTP (Evolved General Packet Radio Service (GPRS) Tunneling Protocol) tunnels between an MME and an S-GW and between an S-GW and a P-GW.

FIG. 10 is a diagram illustrating an overall procedure for transferring data in an EPS system when Control Plane CIoT EPS optimization is used. Specifically, FIG. 10 shows a procedure for transferring mobile-originated data according to the Control Plane CIoT EPS optimization in detail.

0. The UE is in the ECM-IDLE state.

1. The UE establishes an RRC connection and transmits, as part of it, UL data, which is encrypted and integrity-protected, in a NAS message. The UE can also indicate, through release assistance information in the NAS message, whether DL data transmission (e.g. acknowledgements or responses to UL data) subsequent to the UL Data transmission is expected or not. Upon receiving DL data, the UE may indicate whether an S1 connection should be released.

2. The NAS message transmitted in step 1 is relayed to the MME by the eNB using a S1-AP Initial UE message.

3. The MME checks the integrity of the incoming NAS message PDU and decrypts data contained in the NAS message. The MME also decides at this stage whether the data transfer will use SGi or SCEF-based delivery.

4. The MME transmits a Modify Bearer Request message (MME address, MME TEID DL, Delay Downlink Packet Notification Request, and Modify Bearer Request message including RAT type) to the S-GW. The S-GW is now able to transmit DL data to the UE. If the PDN GW requested a location of the UE and/or User CSG Information and if the UE's location and/or User CSG Information has changed, the MME also includes a User Location Information IE and/or a User CSG Information IE in this message. If a Serving Network IE has changed compared to the last reported Serving Network IE, the MME also includes the Serving Network IE in this message. If UE Time Zone has changed compared to the last reported UE Time Zone, the MME includes the UE Time Zone IE in this message.

5. If the RAT type has changed compared to the last reported RAT type or if the UE's location and/or Information IEs and/or UE Time Zone and Serving Network ID are present in step 4, the S-GW transmits the Modify Bearer Request message (RAT type) to the PDN GW. If the User Location Information IE and/or User CSG Information IE and/or Serving Network IE and/or UE Time Zone are present in step 4, they are also included.

If the Modify Bearer Request message is not sent because of above reasons and the PDN GW charging is paused, the S-GW transmits a Modify Bearer Request message with PDN Charging Pause Stop Indication to inform the PDN GW that the charging is no longer paused. Other IEs are not included in this message.

6. The PDN GW sends Modify Bearer Response to the S-GW.

7. The S-GW returns the Modify Bearer Response (an S-GW address and a TEID for uplink traffic) to the MME in response to the Modify Bearer Request message.

8. The MME transmits UL data to the P-GW.

9. If the MME recognizes, based on release assistance information from the UE in step 1, that any DL data is not expected, the MME immediately releases the connection, and therefore step 14 is executed. Otherwise, DL data may arrive at the P-GW, and the P-GW transmits the DL data to the MME. If no data is received, steps 11 to 13 may be skipped. If the RRC connection is active, the UE can still transmit UL data through NAS messages which are carried in a SLAP Uplink message (not shown in FIG. 10). In addition, the UE may provide the release assistance information together with UL data at any time.

10. If DL data is received in step 9, the MME encrypts the DL data and performs integrity-protection of the encrypted DL data.

11. If step 10 is executed, DL data is encapsulated in a NAS message and transmitted to the eNB in a S1-AP DL message. If the release assistance information was received with UL data and it indicated a request to release the RRC connection upon DL data reception, the MME also includes, in the S1-AP message, an indication indicating that the eNB should release the RRC connection after successfully transmitting data to the UE.

12. The eNB transmits RRC DL data including the DL data encapsulated in a NAS PDU. When DL data was received, if a request to tear down the RRC connection was included in the release assistance information, which was sent via the S1-AP message in step 11, the RRC DL data may include a request to immediately release the RRC connection. If so, step 14 is immediately executed.

13. If no NAS activity exists for a while, the eNB starts an S1 release procedure in step 14.

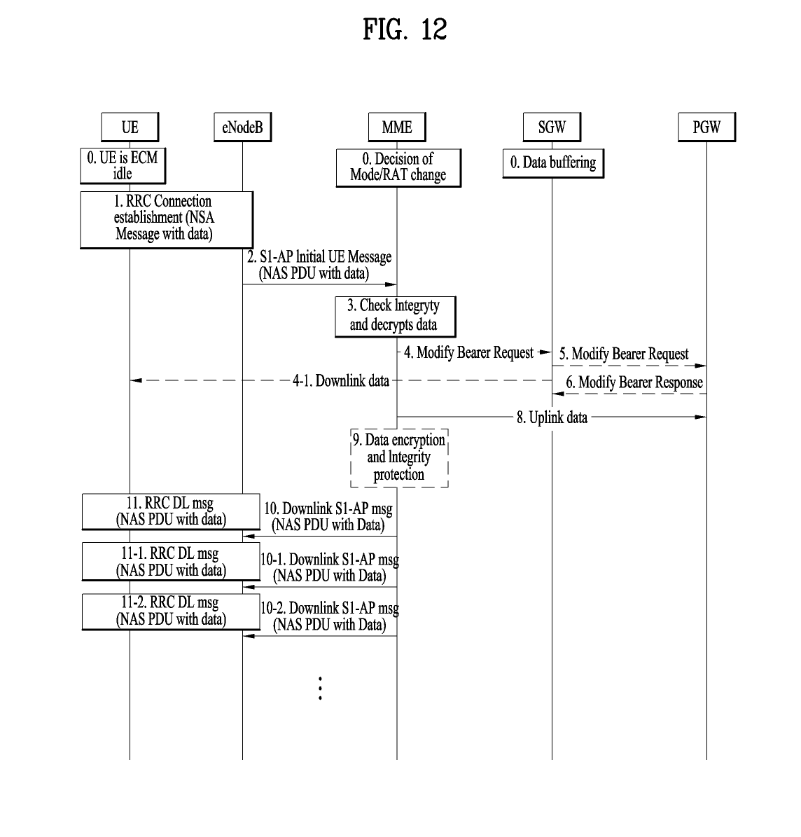

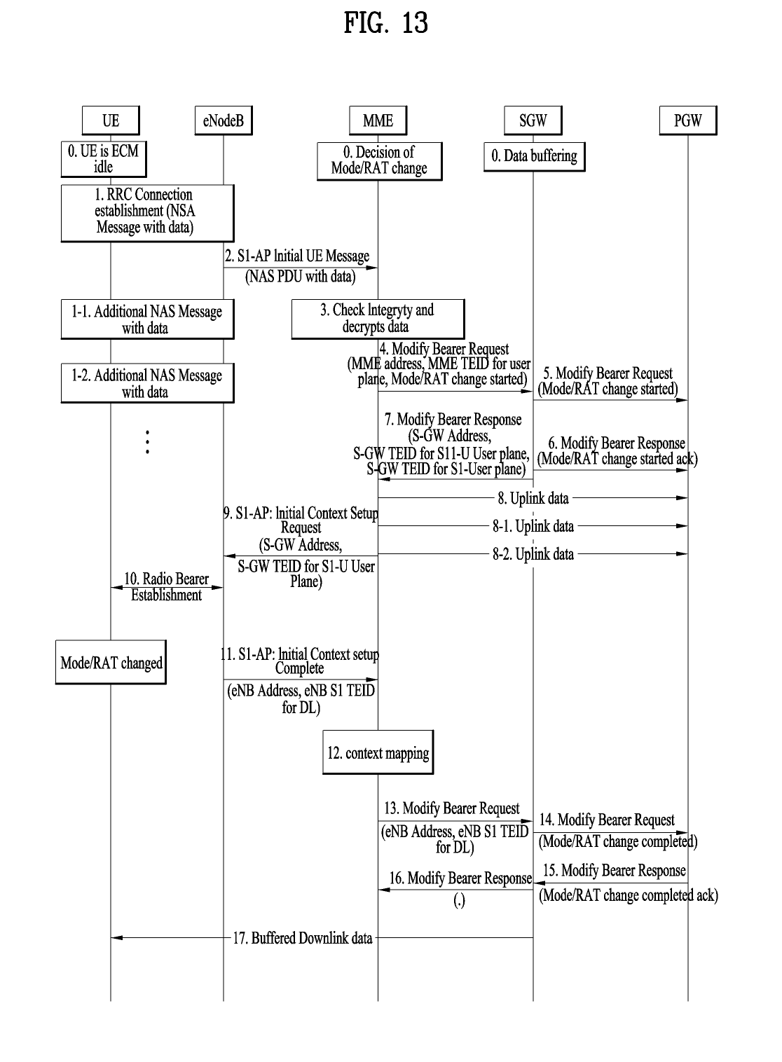

14. The S1 release procedure is performed as described in FIG. 12.

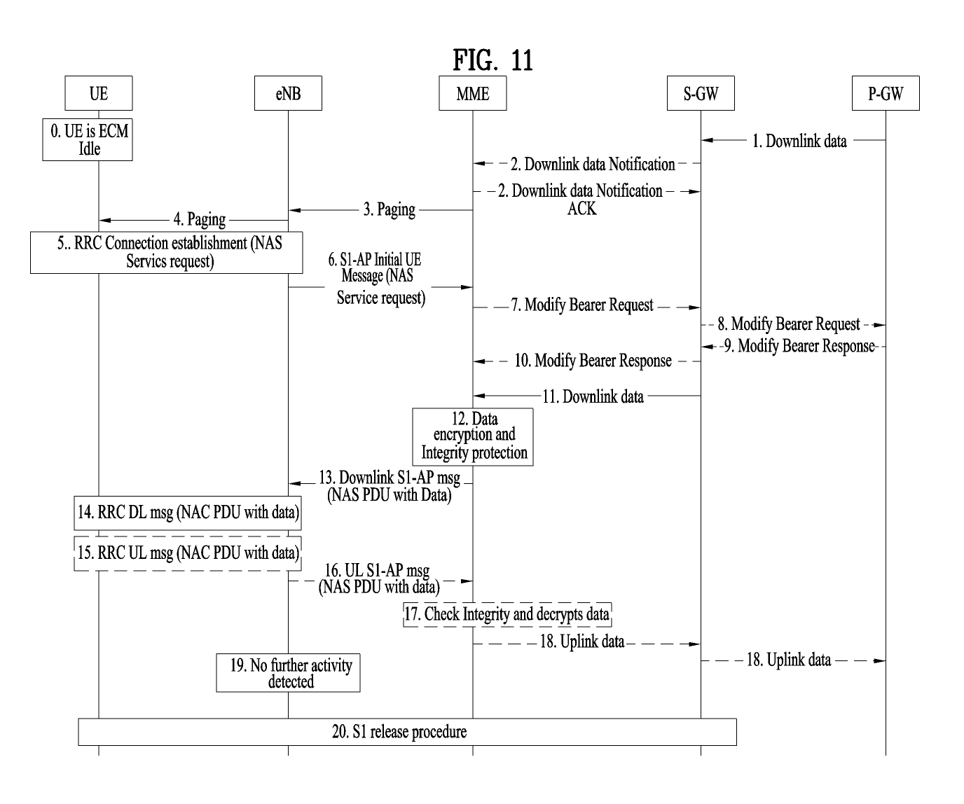

FIG. 11 is a diagram illustrating an overall procedure for transferring mobile-terminated data in an EPS system according to Control Plane CIoT EPS optimization.

0. The UE is attached to the EPS and in the ECM-Idle mode.

1. When the S-GW receives a DL data packet/control signaling for a UE, which is known as not user plane connected (i.e. S-GW context data indicates no DL user plane TEID for the MME), the S-GW buffers the DL data packet and identifies which MME is serving the UE.

2. The S-GW transmits a Downlink Data Notification message (including Allocation and Retention Priority (ARP) and an EPS Bearer ID) to the MME having control plane connectivity with the S-GW for the given UE. The ARP and EPS Bearer ID are always set in Downlink Data Notification. The MME responds to the S-GW using a Downlink Data Notification Ack message.

Upon detecting that the UE is in a power saving state (e.g. power saving mode) and cannot be reached by paging at the time of receiving Downlink Data Notification, the MME invokes extended buffering depending on operator configuration, except for cases described in subsequent paragraphs. The MME derives the expected time before radio bearers can be established for the UE. The MME then indicates DL buffering requested to the S-GW in a Downlink Data Notification Ack message and includes a Downlink Buffering Duration time and optionally a Downlink Buffering Suggested Packet Count. The MME stores a new value for a Downlink Data Buffer Expiration Time in an MM context for the UE based on the Downlink Buffering Duration time and skips the remaining steps of this procedure. The Downlink Data Buffer Expiration Time is used for UEs using the power saving state and indicates that there is buffered data in the S-GW and that a data plane setup procedure is needed when the UE conducts signaling with the network. When the Downlink Data Buffer Expiration Time has expired, the MME considers no DL data to be buffered and no indications of Buffered Downlink Data Waiting are sent during context transfer in tracking area update (TAU) procedures.

If there is an “Availability after DDN Failure” monitoring event configured for the UE in the MME, the MME does not invoke extended buffering. Instead, the MME sets a Notify-on-available-after-DDN-failure flag to remember to send an “Availability after DDN Failure” notification when the UE becomes available. If there is a “UE Reachability” monitoring event configured for the UE in the MME, the MME does not invoke extended buffering.

NOTE: When the “Availability after DDN failure” and “UE Reachability” monitoring events are used for the UE, an application server is assumed to send data only when the UE is reachable and, therefore, no extended buffering is needed. If there are multiple application servers, the event notifications and extended buffering may be needed simultaneously. It is assumed that this is handled through additional information based on service level agreement (SLA) as described in subsequent paragraphs.

The MME may use additional information based on SLA with the MTC user to determine when to invoke extended buffering. For example, the MME invokes extended buffering only for a certain APN, does not invoke extended buffering for certain subscribers, and invokes extended buffering in conjunction with the “Availability after DDN failure” and “UE Reachability” monitoring events, etc.

The S-GW that receives a Downlink Buffering Requested indication in the Downlink Data Notification Ack message stores a new value for the Downlink Data Buffer Expiration Time based on the Downlink Buffering Duration time and does not send any additional Downlink Data Notification if subsequent DL data packets are received in the S-GW before the buffer time Downlink Data Buffer Expiration Time has expired for the UE.

If the S-GW, while waiting for the user plane to be established, is triggered to send a second Downlink Data Notification for a bearer with priority (i.e. ARP priority level) higher than priority of the bearer for which a first Downlink Data Notification has been sent, the S-GW sends a new Downlink Data Notification message indicating the higher priority to the MME. If the S-GW receives additional DL data packets for a bearer with priority identical to or higher than priority of a bearer for which the first Downlink Data Notification has been sent or if the S-GW sends the second Downlink Data Notification message indicating the higher priority and receives additional DL data packets for this UE, the S-GW buffers these DL data packets and does not send the new Downlink Data Notification message.

If the S-GW, while waiting for the user plane to be established, receives a Modify Bearer Request message from an MME other than the MME that has sent the Downlink Data Notification message, the S-GW re-sends the Downlink Data Notification message only to the new MME from which the S-GW has received the Modify Bearer Request message.

Upon reception of the Downlink Data Notification Ack message with an indication that the Downlink Data Notification message has been temporarily rejected and if the Downlink Data Notification message is triggered by the arrival of DL data packets at the S-GW, the S-GW may start a locally configured guard timer and buffer all DL user packets received by the given UE and waits for a Modify Bearer Request message to arrive. Upon reception of the Modify Bearer Request message, the S-GW re-sends the Downlink Data Notification message only to the new MME from which the S-GW has received the Modify Bearer Request message. Otherwise, the S-GW releases the buffered DL user packets upon expiry of the guard timer or upon receiving a Delete Session Request message from the MME.

If the S11-U has already been established (buffering is in the MME), step 2 is not executed and step 11 is immediately executed. Steps 7, 8, 9, and 10 are executed only if conditions are satisfied when the NAS service request is received in step 6.

The MME that has detected that the UE is in a power saving state (e.g. power saving mode) and cannot be reached by paging at the time of receiving Downlink Data Notification invokes extended buffering depending on operator configuration, except for cases described in subsequent paragraphs. The MME derives the expected time before radio bearers can be established to the UE, stores a new value for the Downlink Data Buffer Expiration Time in the MM context for the UE, and skips the remaining steps of this procedure. When the Downlink Data Buffer Expiration Time has expired, the MME considers no DL data to be buffered.

For the case of buffering in the MME, the “Availability after DDN Failure” monitoring event may be configured for the UE, even though actual DDN is not received and DL data is received. The “UE Reachability” monitoring event may also be configured. The extended buffering may also be configured as per what is described above in this step of the procedure for the case of buffering in S-GW.

3. If the UE is registered in the MME and considered reachable, the MME sends a Paging message (NAS ID for paging, TAI(s), UE identity based DRX index, paging DRX length, list of CSG IDs for paging, paging priority indication) to each eNB belonging to the tracking area(s) in which the UE is registered.

4. If eNBs receive the Paging messages from the MME, the UE is paged by the eNBs.

5-6. If the UE is in the ECM-IDLE state, after receiving paging indication, the UE sends a UE Triggered Service Request NAS message over RRC Connection Request and S1-AP Initial messages. The Service Request NAS message, when C-plane CIoT optimization applies, does not trigger S1-U bearer establishment and data radio bearer establishment by the MME and the MME may immediately send DL data that the MME receives using a NAS PDU to the eNB.

7. If the S11-U is not established, the MME sends a Modify Bearer Request message (MME address, MME TEID DL, Delay Downlink Packet Notification Request, and RAT type) to the S-GW. The S-GW is now able to transmit DL data towards the UE. The usage of an information element (IE) of Delay Downlink Packet Notification Request is specified in Section 5.3.4.2 of 3GPP TS 23.401 with reference to the UE initiated service request procedure, but it equally applies in this case. In addition, regardless of whether the S11-U is already established, the usage of the IE applies.

If the PDN GW requested a location of the UE and/or User CSG Information and if the UE's location and/or User CSG Information has changed, the MME also includes a User Location Information IE and/or a User CSG Information IE in this message. If a Serving Network IE has changed compared to the last reported Serving Network IE, the MME also includes the Serving Network IE in this message. If UE Time Zone has changed compared to the last reported UE Time Zone, the MME includes the UE Time Zone IE in this message.

NOTE: if the currently used RAT is NB-IoT, it is reported as an RAT different from E-UTRA.

If the RAT type has changed compared to the last reported RAT type or if the UE's location and/or Information IEs and/or UE Time Zone and Serving Network ID are present in step 7, the S-GW transmits the Modify Bearer Request message (including the RAT type) to the PDN GW. If the User Location Information IE and/or User CSG Information IE and/or Serving Network IE and/or UE Time Zone are present in step 7, they may also be included. Other IEs are not included in this message.

9. The PDN GW transmits Modify Bearer Response to the S-GW.

10. The S-GW returns the Modify Bearer Response (S-GW address and TEID for uplink traffic) to the MME as a response to the Modify Bearer Request message.

11. (When the S11-U is not established) buffered DL data is transmitted by the SOW to the MME.

12-13. The MME encrypts the DL data, performs integrity protection of the encrypted DL data, and then sends it to the eNB using a NAS message carried by a DL S1-AP message.

14. A NAS PDU with data is delivered to the UE via a DL RRC message. This is taken by the UE as acknowledgment (Ack) of the Service request message sent in step 5.

15. While the RRC connection is still activated, further UL and DL data may be sent using NAS PDUs. It can be seen that in step 16, UL data transmission is performed using an UL RRC message encapsulating the NAS PDU with data. The UE may provide release assistance information with UL data in the NAS message at any time.

16. The NAS PDU with data is transmitted to the MME via a UL S1-AP message.

17. The integrity of the data is checked, and it is decrypted.

18. The MME transmits UL data to the P-GW through the S-GW and executes an action related to the presence of release assistance information after performing behavior for mobile-originated (MO) data transfer.

19. If no NAS activity exists for a while, the eNB detects inactivity and executes step 20.

20. The eNB starts an eNB initiated S1 release procedure as shown in FIG. 12 according to Section 5.3.5 of 3GPP TS 23.401.

A power saving mode (PSM) or extended discontinuous reception (eDRX) may be considered. A normal LTE paging cycle during which a UE can be contacted by a network if traffic is queued for the UE is 1.28s. eDRX extends a cycle during which the UE may be in an idle state to more than 1.28s. Accordingly, when there is no need to frequently awake, as in the case of an MTC UE, eDRX may be applied to reduce battery consumption. The PSM is a mode in which the UE informs the network that the UE will enter an indefinitely dormant state. At a predefined time or if data to be transmitted is present, the UE in the PSM wakes up and transmits data to the network, and remains in an idle state during a predetermined time so that the UE is reachable if needed. Since the UE is dormant during the entire PSM window, power consumption of the UE is extremely low.

In a legacy system prior to introduction of the PSM or eDRX, if an S1-U is in an idle state, the S-GW transmits a downlink data notification (DDN) message to the MME while buffering a DL packet and the MME that has received the DDN message transmits a paging message to eNB(s). The UE that has received the paging message starts to perform a service request procedure. As the PSM or eDRX, which is a state in which the UE cannot be reachable even though the UE is in an idle state, i.e., a state in which the UE cannot respond even though the network transmits the paging message, is introduced, a situation may occur in which the S-GW has received DL data but transmission of the DDN message is invalid. Therefore, in some cases, the S-GW needs to perform buffering for a longer period than in the legacy system.

For example, assume that the UE uses a C-plane solution. In this case, if the network recognizes that the UE is in the eDRX or PSM state, the S-GW buffers DL data of the UE.

If the amount of data buffered in the S-GW exceeds a predetermined threshold, the S-GW may consider informing the MME that the amount of data buffered in the S-GW exceeds the predetermined threshold. Then, the MME may recognize that the amount of data buffered in the S-GW exceeds the predetermined threshold and determine that mode/RAT change is needed. If mobile-originated (MO) data is generated for the UE so that the UE transmits the data to the C-plane solution (e.g., refer to FIG. 10) and the MME receives the MO data together with a NAS message, a situation as illustrated in FIG. 12 may arise.

FIG. 12 illustrates problems caused by not performing mode/RAT change when a large amount of mobile-terminated (MT) data is generated for a UE which is using C-plane CIoT EPS optimization. Operation of steps 1 to 8, step 9, step 10, and step 11 of FIG. 12 has been are described in steps 1 to 8, step 10, step 11, and step 12 of FIG. 10, respectively.

Referring to FIG. 12, if an MME that has received a NAS message and MO data from the UE transmits GTP signaling to an S-GW in step 4, the S-GW may determine that the UE is reachable and send DL data buffered in the S-GW to the UE. In other words, if the S-GW confirms that the UE is reachable, the S-GW sends the DL data buffered in the S-GW to the HE, regardless of whether a connection established for the UE is a C-plane connection or a U-plane connection, i.e., regardless of a bearer type. A small amount of data may be efficiently transmitted to the C-plane solution. However, if a large amount of data is transmitted to the C-plane solution, since the large amount of data cannot be carried in one NAS message as illustrated in steps 11 to 11-2 of FIG. 12, multiple NAS messages should be transmitted, thereby causing inefficiency.

Generally, if the U-plane connection is to be established, the UE should send a service request or send an active flag through a TAU request message. Referring to the service request procedure described with respect to FIG. 8 and the TAU procedure described in Section 5.3.3.2 of 3GPP TS 23.401 V 12.10.0, it will be appreciated that the U-plane connection through the service request procedure and the TAU procedure may cause high signaling overhead between the network and the UE. Furthermore, if the UE which is using the C-plane solution desires to transition to the U-plane connection, the UE should make a request for the U-plane connection after waiting until the UE enters an EMM-IDLE mode. If the UE of steps 11 to 11-2 continues to maintain an EMM-Connected mode, the UE transitions to the EMM-IDLE mode only after an inactivity time elapses since all data has been transmitted. That is, in FIG. 12, the UE should receive all buffered data through a C-plane.

The present invention proposes methods for solving the above-described problems. In the present invention, “mode” represents a C-plane CIoT optimization mode (i.e., C-plane solution mode) or a U-plane CIoT optimization mode (i.e., U-plane solution mode). “RAT” represents NB-IoT RAT or LTE RAT. In addition, “mode/RAT change” represents that a UE which has operated in a C-plane CIoT optimization mode/RAT changes a mode/RAT to a U-plane CIoT mode or a UE which has operated in a legacy LTE system changes a mode/RAT to an NB-IoT system. In the present invention, an S11-U connection represents a connection on an S11 interface through which data is transmitted between the MME and the S-GW in C-plane CIoT optimization.

As described earlier, if the amount of data buffered in the S-GW exceeds a predetermined threshold, the S-GW considers informing the MME that the amount of data buffered in the S-GW exceeds the threshold. In this case, the S-GW may recognize the threshold which is a switching criterion using the following methods.

The S-GW determines the threshold. If the amount of data accumulated or buffered in the S-GW exceeds the threshold, the S-GW transmits the following information to the MME.

The S-GW informs the MME of an actual data size. Alternatively, the S-GW informs the MME that there is a large amount of data or a small amount of data or that mode/RAT change is needed.

The threshold may be pre-configured or may be transmitted to the S-GW according to A and/or B described below during an attach/TAU procedure of the UE.

A. After the UE transmits an attach/TAU request message including the threshold to the MME, the MME transmits a GTP message (e.g., Create Session request or Modify Bearer request) to the S-GW: step 12 in “Attach procedure” in Section 5.3.2.1 of 3GPP TS 23.401 V 12.10.0 and/or step 9 in “Tracking area update procedure” in Section 5.3.3.2 of 3GPP TS 23.401 V 12.10.0.

B. When the attach/TAU request message from the UE has CIoT optimization capability, the MME transmits subscription information or a pre-configured threshold to the S-GW. Step(s) of transmitting the threshold are the same as in A.

If the amount of data accumulated or buffered in the S-GW always exceeds the threshold, the S-GW informs the MME that the amount of data exceeds the threshold through GTP signaling (e.g., Downlink Data Notification message or Modify Bearer Request message).

FIG. 13 illustrates mode/RAT change according to the present invention.

The present invention assumes that, when MO data is generated with respect to a UE which is using a C-plane solution, the UE transmits the MO data to the C-plane solution, and the MME receives the MO data together with a NAS message and then transmits the MO data through an S11-U interface. The present invention proposes that a mode be changed during transmission of DL (or MT) data when the network buffers a large amount of data.

A UE in a PSM or eDRX state is incapable of receiving paging from a network. Therefore, even though MT data for the UE arrives at the S-GW, the MT data is stacked in the S-GW because the S-GW cannot send the MT data. Thus, when the S-GW buffers the DL data for the UE that is not reachable, if the amount of the data buffered in the S-GW exceeds a predetermined threshold, the S-GW may inform the MME that the amount of data exceeds the threshold. Upon recognizing that the data buffered in the S-GW exceeds the threshold, the MME determines that mode/RAT change is needed. An MT data transfer procedure according to the present invention will now be described with reference to FIG. 12.

Step 0. A network detects that a UE is in an eDRX or PSM state and an S-GW buffers DL data of the UE. If the amount of the data buffered in the S-GW exceeds a predetermined threshold, the S-GW may inform an MME that the amount of the data exceeds the threshold. Then, the MME recognizes that the amount of the data buffered in the S-GW exceeds the predetermined threshold, determines that the buffered data needs to be transmitted to a U-plane, and, for this, determines to set up an S1-U connection. In this case, the MME may inform the S-GW, through an indication or an IE, that mode change will be performed. Herein, the S-GW buffers the data until the S1-U connection is established and does not transmit the buffered DL data even though the S-GW is aware that an S11-U connection has been established or that the UE is reachable through MO signaling (e.g., Modify Bearer Request in the TAU procedure).

Steps 1 to 3. MO data is generated with respect to the UE so that the UE transmits the MO data to the C-plane solution and the MME receives the MO data together with a NAS message.

Step 4. If the S11-U connection has not been established, the MME transmits a Modify Bearer Request message including an MME IP address and an MME TEID for a U-plane to the S-GW in order to set up the S11-U connection. Herein, the MME includes, in the Modify Bearer Request message, an IE or indication ‘Mode/RAT change started’ indicating that mode/RAT change will be performed.

When the S11-U connection has been established, if the DL data arrives at the S-GW, the S-GW may immediately transmit the DL data to the MME. If the MME determines that mode change is needed (e.g., if the MME determines that mode change is needed because the amount of the buffered data exceeds the threshold as described above) while receiving the DL data, the MME commands the S-GW to stop transmitting the data. Then, the S-GW buffers the DL data instead of transmitting the DL data to the MME. If the S1-U connection is established, the S-GW transmits packets buffered therein and subsequent packets on the S1-U connection. Even in this case, the MME includes, in the Modify Bearer Request message, the IE or indication ‘Mode/RAT change started’ indicating that mode/RAT change will be performed. The IE or indication ‘Mode/RAT change started’ may serve to cause the S-GW to stop transmitting the DL data to the MME and buffer the DL data.

Steps 5 and 6. If the IE or indication ‘Mode/RAT change started’ indicating that mode/RAT change will be performed is included in the Modify Bearer Request message, the S-GW may transfer the IE or indication ‘Mode/RAT change started’ to a P-GW. Upon receiving the IE or indication ‘Mode/RAT change started’ the P-GW transfers Ack for the received IE or indication to the S-GW through an IE or indication.

Step 7. Upon receiving the Modify Bearer Request message, the S-GW transmits a Modify Bearer Response message including an S-GW IP address and an S-GW TEID for an S11-U plane in order to set up the S11-U connection.

If the Modify Bearer Request message includes the IE or indication ‘Mode/RAT change started’ indicating that mode change will be performed, the S-GW does not transmit the buffered DL data on the S11-U connection and maintains buffering until S1-U connection is set up. The S-GW transmits the Modify Bearer Response message including the S-GW TEID for the S1-U plane to the MME in order to set up the S1-U connection.

Step 8. If the Modify Bearer Response is received and the S11-U connection is established, the MME transmits UL data on the S11-U connection. As described in Steps 1-1 and 1-2, even UL data transmitted after the first UL data may also be transmitted through the S11-U connection. Transmission using the S11-U connection may be performed up to Step 11.

Steps 9 to 11. The MME transmits an Initial Context Setup Request message including an S-GW IP address and an S-GW TEID for an S1-U plane to the eNB. Upon receiving the Initial Context Setup Request message, the eNB performs data radio bearer (DRB) setup with the UE (Step 10) and transmits an Initial Context Setup Response message including an eNB IP address and an eNB S1 TEID for DL to the MME. If a DRB is established in Step 10, the UE recognizes that mode/RAT has been changed to a U-plane mode.

Step 12. Upon receiving the Initial Context Setup Response message, the MME performs a context mapping procedure for mode/RAT change.

Step 13. The MME transmits a Modify Bearer Request message including the eNB IP address and the eNB S1 TEID for DL received in Step 11 to the S-GW in order to set up the S1-U connection.

Steps 14 and 15. The S-GW informs the P-GW that the S1-U connection has been established through an IE or indication ‘Mode/RAT change Completed’. The P-GW may transmit Ack as a response message. Thereby, the P-GW may recognize that mode change has been completed and perform necessary preparation or operation.

Step 16. The S-GW transmits a Modify Bearer Response message to the MME.

Step 17. The S-GW recognizes that the S1-U connection has been established and starts to transmit the buffered DL data through the S1-U connection. The UE starts to receive the data in the changed U-plane mode. If the S1-U connection is established, DL data is transmitted to the UL from the S-GW through the S1-U connection (without passing through the MME).

The above-described ‘Mode/RAT change started’ (e.g., the IE or indication included in the Modify Bearer Request message of Step 4) may perform the following roles.

Role indicating that mode/RAT change is started.

Role for causing the S-GW to maintain buffering until the S1-U connection is established when the S-GW buffers DL data (i.e., MT data) (in the case in which the S11-U connection has not been established).

Role for causing the S-GW to stop forwarding DL data and maintain buffering until the S1-U connection is established when the S-GW forwards the DL data to the MME (in the case in which the S11-U connection has been established).

Role for requesting that the S-GW transmit an S-GW TEID for an S1-U plane, needed to establish the S1-U connection.

These roles may be processed through one IE or indication ‘Mode/RAT change started’. An additional IE or indication may be used according to role.

When MO signaling (e.g., a TAU request message) rather than the MO data is generated, e.g., even though the message of step 1 in FIG. 13 is a NAS message which does not include data, the present invention is equally applied except for steps (e.g., Steps 3 and 8) related to UL data transmission.

The C-plane solution described with reference to FIGS. 11 and 12 does not include Steps 9 to 11 described with reference to FIG. 13. Therefore, according to the C-plane solution described in FIGS. 11 and 12, the U-plane connection may be established only when the UE transmits a service request or transmits an active flag through the TAU request message. In contrast, according to the present invention described with reference to FIG. 13, mode/RAT change may be performed even though the TAU procedure or the service request procedure is not completely performed. Furthermore, if a UE which is using the C-plane solution desires to transition to the U-plane connection, the UE should wait until the UE becomes a state of an EMM-IDLE mode and then request the U-plane connection. If the UE in Steps 11 to 11-2 of FIG. 12 continues to maintain the state of the EMM-connection mode, the UE transitions to the EMM-IDLE mode only after an inactivity time elapses since all data has been transmitted. That is, in FIG. 12, the UE should receive all buffered data through the C-plane. Therefore, according to mode/RAT change initialized by the network, proposed in the present invention, transmission efficiency can be raised and signaling overhead can be reduced, through mode change during generation of a large amount of MT data.

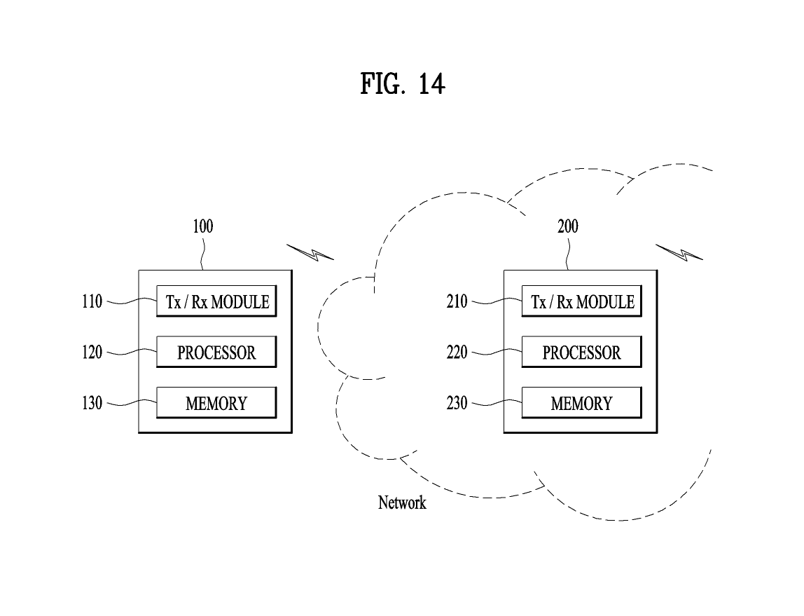

FIG. 14 is a diagram illustrating configurations of node devices according to a proposed embodiment.

A user equipment (UE) 100 may include a transceiver 110, a processor 120, and a memory 130. The transceiver 110 can be referred to as a radio frequency (RF) unit. The transceiver 110 may be configured to transmit and receive various signals, data, and information to/from an external device. Alternatively, the transceiver 110 may be implemented with a combination of a transmitter and a receiver. The UE 100 may be connected to the external device by wire and/or wirelessly. The processor 120 may be configured to control overall operations of the UE 100 and process information to be transmitted and received between the UE 100 and the external device. Moreover, the processor 120 may be configured to perform the UE operation proposed in the present invention. In addition, the processor 120 may be configured to control the transceiver 110 to transmit data or messages according to the proposals of the present invention. The memory 130, which may be replaced with an element such as a buffer (not shown in the drawing), may store the processed information for a predetermined time.

Referring to FIG. 14, a network node 200 according to the present invention may include a transceiver 210, a processor 220, and a memory 230. The transceiver 210 can be referred to as a radio frequency (RF) unit. The transceiver 210 may be configured to transmit and receive various signals, data, and information to/from an external device. The network node 200 may be connected to the external device by wire and/or wirelessly. The processor 220 may be configured to control overall operations of the network node 200 and process information to be transmitted and received between the network node device 200 and the external device. Moreover, the processor 220 may be configured to perform the network node operation proposed in the present invention. In addition, the processor 220 may be configured to control the transceiver 210 to transmit data or messages to a UE or another network node according to the proposals of the present invention. The memory 230, which may be replaced with an element such as a buffer (not shown in the drawing), may store the processed information for a predetermined time.

The specific configurations of the UE 100 and the network node 200 may be implemented such that the aforementioned various embodiments of the present invention can be independently applied or two or more embodiments can be simultaneously applied. For clarity, redundant description will be omitted.

The embodiments of the present invention may be implemented using various means. For instance, the embodiments of the present invention may be implemented using hardware, firmware, software and/or any combinations thereof.

In case of the implementation by hardware, a method according to each embodiment of the present invention may be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present invention can be implemented by modules, procedures, and/or functions for performing the above-explained functions or operations. Software code may be stored in a memory unit and be then executed by a processor. The memory unit may be provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. Therefore, the present invention is non-limited by the embodiments disclosed herein but intends to give a broadest scope matching the principles and new features disclosed herein.

### INDUSTRIAL APPLICABILITY

The aforementioned communication method can be applied to various wireless communication systems including IEEE 802.16x and 802.11x systems as well as the 3GPP system. Further, the proposed method is applicable to a millimeter wave (mm Wave) communication system using ultra-high frequency bands.

1. A method for changing a connection mode by a mobile management entity (MME) in a wireless communication system, the method comprising:
receiving, from a serving gateway (S-GW), information indicating that an amount of downlink (DL) data for a user equipment (UE), buffered in the S-GW, exceeds a threshold;
transmitting, to the S-GW, a mode change notification indicating that a connection mode with the UE, which is using a control plane connection for transferring user plane data, will be changed to a user plane; and
requesting an eNode B (eNB) to set up a user plane connection with the UE.

2. The method according to claim 1, wherein, if the UE is in a power saving mode or an extended discontinuous reception (eDRX) state, the DL data is buffered in the S-GW.

3. The method according to claim 1, wherein the DL data is transmitted to the UE from the S-GW through the eNB on the user plane connection, if the user plane connection is established.

4. The method according to claim 1, further comprising:
receiving, from the UE, uplink (UL) data or a UL signal as a non-access stratum (NAS) message; and
transmitting, to the S-GW, the UL data on the control plane connection when the control plane connection for transferring the user plane data is established with the S-GW.

5. The method according to claim 1, wherein, if the mode change notification is transmitted to the S-GW, the DL data is not received from the S-GW on the control plane Connection.

6. The method according to claim 1, further comprising transmitting the mode change notification to the S-GW together with a setup request of the control plane connection, if the control plane connection for transferring the user plane data is not established with the S-GW.

7. The method according to claim 6, wherein, if the mode change notification is transmitted to the S-GW, the DL data is not received from the S-GW on the control plane connection.

8. A mobility management entity (MME) for changing a connection mode in a wireless communication system, the MME comprising,
a transceiver; and
a processor configured to control the transceiver,
wherein the processor is configured to:
control the transceiver to receive, from a serving gateway (S-GW), information indicating that an amount of downlink (DL) data for a user equipment (UE), buffered in the S-GW, exceeds a threshold;
control the transceiver to transmit, to the S-GW, a mode change notification indicating that a connection mode with the UE, which is using a control plane connection for transferring user plane data, will be changed to a user plane; and
control the transceiver to request an eNode B (eNB) to set up a user plane connection with the UE.

9. The MME according to claim 8, wherein, if the UE is in a power saving mode or an extended discontinuous reception (eDRX) state, the DL, data is buffered in the S-GW.

10. The MME according to claim 8, wherein the DL data is transmitted to the UE from the S-GW through the eNB on the user plane connection, if the user plane connection is established.

11. The MME according to claim 8, wherein the processor is configured to:
control the transceiver to receive, from the UE, uplink (UL) data or a UL signal as a non-access stratum (NAS) message; and
control the transceiver to transmit, to the S-GW, the UL data on the control plane connection when the control plane connection for transferring the user plane data is established with the S-GW.

12. The MME according to claim 8, wherein, if the mode change notification is transmitted to the S-GW, the DL data is not received from the S-GW on the control plane connection.

13. The MME according to claim 8, wherein, if the control plane connection for transferring the user plane data is not established with the S-GW, the processor is configured to control the transceiver to transmit the mode change notification to the S-GW together with a setup request of the control plane connection.

14. The MME according to claim 13, wherein, if the mode change notification is transmitted to the S-GW, the DL data is not received from the S-GW on the control plane connection.
